(19) United States
(12) Patent Application Publication
(10) Pub. No.: US 2018/0068120 A1
(43) Pub. Date: Mar. 8, 2018

(54) RECORDING MEDIUM FOR STORING PROGRAM FOR MALWARE DETECTION, AND APPARATUS AND METHOD FOR MALWARE DETECTION

(71) Applicant: Fujitsu Limited, Kawasaki-shi (JP)

(72) Inventors: Hirotaka Kokubo, Minato (JP); Kazuyoshi Furukawa, Kawasaki (JP); Masahiko Takenaka, Kawasaki (JP)

(73) Assignee: Fujitsu Limited, Kawasaki-shi (JP)

(21) Appl. No.: 15/678,290

(22) Filed: Aug. 16, 2017

(30) Foreign Application Priority Data
Sep. 5, 2016 (JP) 2016-173061

(51) Int. Cl. G06F 21/56

(52) U.S. Cl. CPC G06F 21/56

(57) ABSTRACT

A method for malware detection includes: executing transmission processing that includes adding information pertaining to a specific file to a file list obtained from a storage device upon receiving a transmission command for the file list from an application, and transmitting, to the application, the file list to which the information pertaining to the specific file has been added; and executing determination processing that includes determining that the application is malware upon receiving an operating command pertaining to the specific file from the application.

### CROSS-REFERENCE TO RELATED APPLICATION

This application is based upon and claims the benefit of priority of the prior Japanese Patent Application No. 2016-173061, filed on Sep. 5, 2016, the entire contents of which are incorporated herein by reference.

### FIELD

The embodiments discussed herein are related to a non-transitory computer-readable storage medium for storing a program for malware detection, and to an apparatus and a method for malware detection.

### BACKGROUND

A security administrator (referred to below simply as an administrator) in a company or an organization desirably avoids, for example, the improper acquisition or destruction (referred to below as a malicious action) of information by a program (referred to below as malware) and the like for performing harmful actions including a computer virus.

Specifically, ransomware, which is one type of malware, is transmitted as an attachment to an email, for example, transmitted from an external device (referred to below simply as an external terminal) by a malicious person, and is executed in a terminal device that receives the email whereby files inside the terminal device are encrypted. The malicious person who transmitted the email to which the ransomware was attached then demands compensation as a condition for handing over an encryption key for deciphering the encrypted files.

Consequently, the administrator previously installs antivirus software, for example, in the terminal device (e.g., a terminal device that stores important files). As a result, the administrator avoids damages due to ransomware and other types of malware.

Examples of the related art include Japanese Laid-open Patent Publication No. 2016-033690, Japanese Laid-open Patent Publication No. 2006-011552, and Japanese Laid-open Patent Publication No. 2007-334536.

### SUMMARY

According to an aspect of the invention, a non-transitory computer-readable storage medium for storing a program for malware detection is provided. The program causes a computer to execute series of processes which have: (1) executing transmission processing that includes adding information pertaining to a specific file to a file list obtained from a storage device upon receiving a transmission command for the file list from an application, and transmitting, to the application, the file list to which the information pertaining to the specific file has been added; and (2) executing determination processing that includes determining that the application is malware upon receiving an operating command pertaining to the specific file from the application.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an overall configuration of an information processing system;

FIG. 2 is a diagram for explaining a detailed example when a malicious person transmits malware to a terminal device;

FIG. 3 is a diagram for explaining a hardware configuration of a terminal device 1;

FIG. 4 is a functional block diagram of the terminal device depicted in FIG. 3;

FIG. 5 is a flow chart for explaining an outline of malware detection processing according to a first embodiment;

FIG. 6 is a flow chart for explaining an outline of malware detection processing according to the first embodiment;

FIG. 7 is a diagram for explaining an outline of malware detection processing according to the first embodiment;

FIG. 8 is a flow chart for explaining an outline of malware detection processing according to the first embodiment;

FIG. 9 is a diagram for explaining an outline of malware detection processing according to the first embodiment;

FIG. 10 is a diagram for explaining an outline of malware detection processing according to the first embodiment;

FIG. 11 is a flow chart for explaining details of malware detection processing according to the first embodiment;

FIG. 12 is a flow chart for explaining details of malware detection processing according to the first embodiment;

FIG. 13 is a diagram for explaining a detailed example of file list information;

FIG. 14 is a diagram for explaining a detailed example of the file list information;

FIG. 15 is a diagram for explaining a detailed example of the file list information; and

FIG. 16 is a diagram for explaining details of malware detection processing according to the first embodiment.

### DESCRIPTION OF EMBODIMENT

Conventionally, new types of malware that antivirus software does not handle or malware that does not perform operations that can be detected by antivirus software are present among the malware executed in a terminal device. As a result, antivirus software may not be able to accurately detect malware that is being executed in the terminal device.

However, if backup data is kept by the terminal device, the administrator is able to roll back the terminal device to a stage before receiving the attack by the malware. As a result, even if an attack is received due to ransomware and the like, the administrator is able to obtain the files in the state before receiving the attack.

However, when performing a roll back in the terminal device, the work contents performed in the period subject to the roll back are lost. As a result, when the interval between which backup data is obtained is long in the terminal device, for example, the administrator may not be able to perform the roll back of the terminal device.

Accordingly, an object according to one aspect is to provide a malware detection program, a malware detection device, and a malware detection method for the accuracy for detecting malware is improved.

(Configuration of Information Processing System)

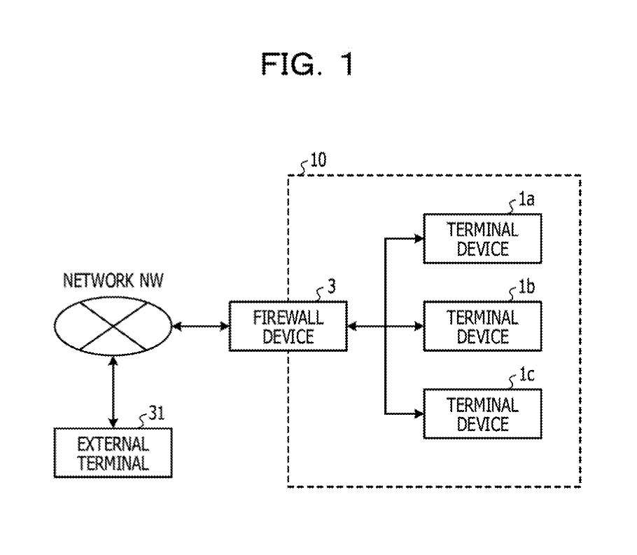

FIG. 1 is a diagram for explaining an overall configuration of an information processing system 10. The information processing system 10 depicted in FIG. 1 has terminal devices 1a, 1b and 1c (referred to below collectively as terminal device 1 or as malware detection device 1) and a firewall device 3.

The terminal device 1 is used by a work system developer or administrator in a company or organization. Specifically, the terminal device 1 is a desktop personal computer (PC) or a notebook PC for example.

The firewall device 3 controls communication between the terminal device 1 and an external terminal 31 connected to a network NW. That is, the firewall device 3 defends against illegal accesses and the like to the terminal device 1 from the external terminal 31, for example. The network NW is, for example, an internet network.

(Detailed Exampled when Malware is Transmitted from an External Terminal)

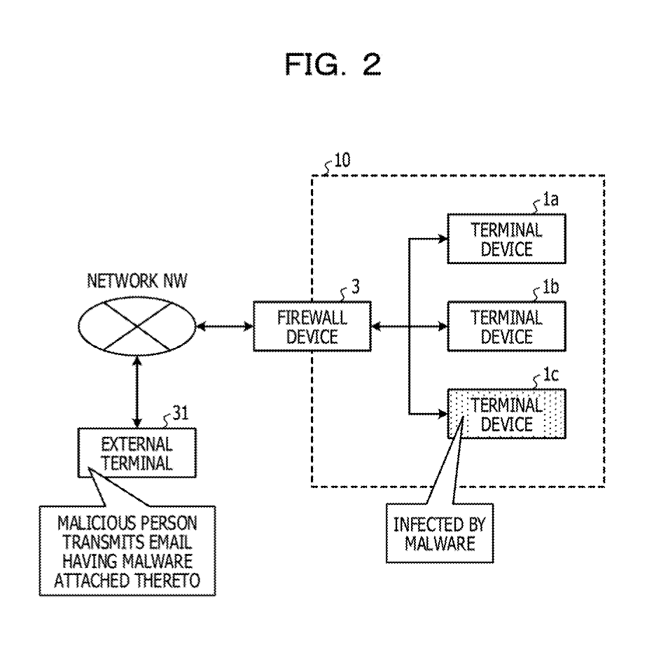

The following is an explanation of a detailed example when malware is transmitted to the terminal device 1c via the external terminal 31 by a malicious person. FIG. 2 is a diagram for explaining a detailed example when a malicious person transmits malware to a terminal device 1c.

A malicious person transmits an email (an email disguised as an email having a normal executable file attached thereto) to which malware is attached through the external terminal 31, for example, to the terminal device 1c as depicted in FIG. 2. Specifically, the malicious person decides in advance a target (such as a specific company), for example, for carrying out the improper acquisition of information and transmits an email having the malware attached thereto to a terminal device (terminal device 1c) of the target (referred to below also as a targeted attack).

In this case, the firewall device 3 may not be able to determine that malware is attached to the email transmitted from the external terminal 31 and may not discard the email. As a result, the terminal device 1 may be infected by the malware due to a user executing the malware attached to the transmitted email as depicted in FIG. 2.

Accordingly, the administrator previously installs antivirus software, for example, in the terminal device (e.g., a terminal device that stores important files). For example, when the content of the operation of the application to be operated in the terminal device 1 is the same as an operation of malware that has been analyzed in the past, the antivirus software determines that the application is malware and removes the malware. As a result, the administrator is able to limit damage caused by malware such as ransomware.

However, the malware executed in the terminal device 1 may be a new type of malware (malware that the antivirus software does not handle). Further, the malware executed in the terminal device 1 may be malware that does not perform an operation that can be detected by the antivirus software. As a result, the administrator is not able to detect the malware executed in the terminal device 1 in the above cases.

However, when backup data is obtained by the terminal device 1, the administrator, for example, performs a roll back of the terminal device to a stage before being affected by the damage caused by the malware. As a result, even after an attack is received due to malware, the administrator is able to obtain the files of the state before receiving the attack.

However, when performing a roll back in the terminal device 1, the work contents performed during the period in which the roll back is performed are lost. As a result, when the interval between which the backup data is obtained is long in the terminal device 1, for example, the administrator may not be able to perform the roll back of the terminal device 1.

Accordingly, a hypervisor of the terminal device 1 according to the present embodiment obtains a file list stored in a storage device when a file list transmission command is received from an application. Specifically, the hypervisor of the terminal device 1 obtains a file list stored in the storage device in response to an operating system (OS) receiving a transmission command of the file list transmitted from the application.

The hypervisor of the terminal device 1 then adds information pertaining to a file (referred to below as a specific file) created by the hypervisor itself, for example, to the file list and transmits the file list to the application. Thereafter, the hypervisor of the terminal device 1 determines that the application is malware upon receiving an operating command with regard to the specific file from the application.

That is, when the specific file is a file created by the hypervisor of the terminal device 1, a normal application (an application that is not malware) does not have to carry out an operation such as writing over or erasing the specific file. As a result, the normal application does not carry out an operation such as writing over the specific file when information pertaining to the specific file is included in the obtained file list.

Conversely, if the transmission source of the transmission command for the file list is malware (e.g., ransomware) that infects the terminal device 1, the malware, for example, attacks (writing for encrypting the files or erasing the files and the like) all of the files for which information is included in the obtained file list. That is, if the transmission source of the transmission command for the file list is malware that infects the terminal device 1, the malware performs an operation on the specific file created by the hypervisor.

The hypervisor of the terminal device 1 transmits a file list in which information pertaining to the specific file has been added, to the application upon receiving the transmission command of the file list from the application. The hypervisor of the terminal device 1 then determines that the application is malware upon receiving an operating command such as writing and the like with regard to the specific file from the application.

As a result, the hypervisor of the terminal device 1 is able to detect whether the transmission source of the transmission command of the file list is malware or not. The hypervisor of the terminal device 1 is able to accurately detect the presence of the malware. Therefore, the hypervisor of the terminal device 1 is able to effectively avoid attacks on the files in the terminal device 1.

(Hardware Configuration of Terminal Device)

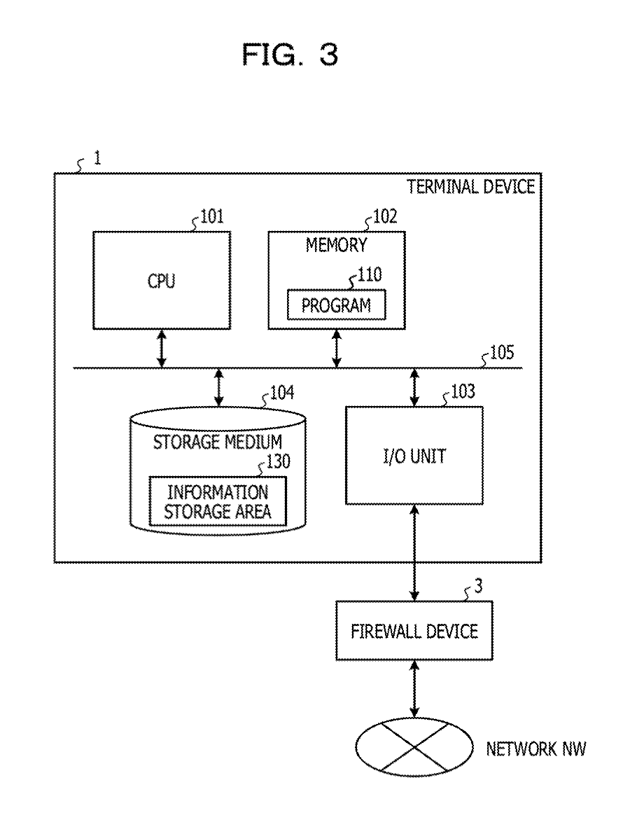

The following is an explanation of a hardware configuration of the terminal device 1. FIG. 3 is a diagram for explaining a hardware configuration of a terminal device 1.

The terminal device 1 has a CPU 101 that is a processor, a memory 102, an external interface (I/O unit) 103, and a storage medium 104. All the units are connected to each other over a bus 105.

For example, the storage medium 104 stores, in a program storage area (not illustrated) in the storage medium 104, a program 110 for carrying out processing (referred to below as malware detection processing) and the like for detecting malware. The storage medium 104 is, for example, a hard disk drive (HDD) or a solid state drive (SSD).

The CPU 101 loads the program 110 from the storage medium 104 to the memory 102 when executing the program 110 and carries out the malware detection processing in cooperation with the program 110 as depicted in FIG. 3.

The storage medium 104 has an information storage area 130 (referred to below as storage unit 130 or storage device 130) for storing information used when carrying out the malware detection processing, for example. The storage unit 130 functions as an information storage area controlled by the hypervisor of the terminal device 1, for example.

Moreover, the external interface 103 carries out communication with the network NW through the firewall device 3.

(Software Configuration of Terminal Device)

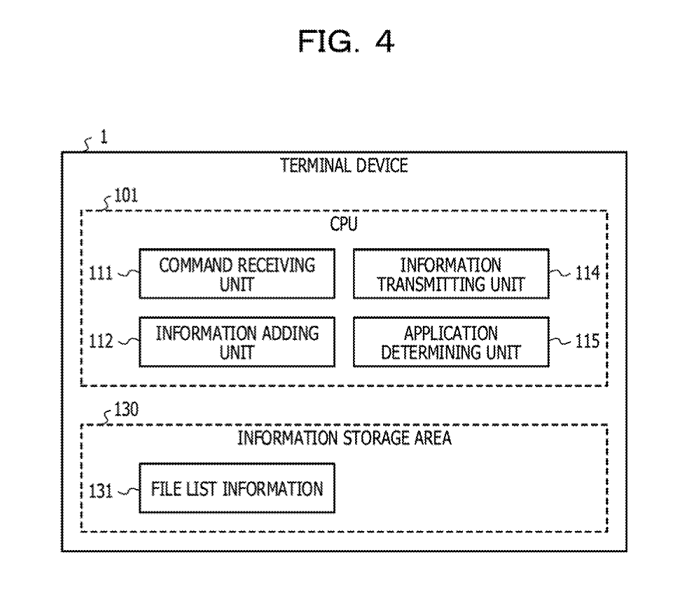

The following is an explanation of a software configuration of the terminal device 1. FIG. 4 is a functional block diagram of the terminal device 1 depicted in FIG. 3. The CPU 101 cooperates with the program 110 thereby functioning as a command receiving unit 111, an information adding unit 112, an information transmitting unit 113, and an application determining unit 114 (referred to below simply as determination unit 114) which are functions of the hypervisor of the terminal device 1. Moreover, file list information 131 is stored in the information storage area 130.

The command receiving unit 111 receives a command (e.g., file list transmission command or file operating command) transmitted to the OS from an application. Specifically, the command receiving unit 111 hooks the command when it is detected that a command is transmitted from the application to the OS.

The information adding unit 112 obtains the file list information 131 stored in the information storage area 130 when the transmission command of the file list (referred to below as the file list information 131) transmitted from the application is hooked by the command receiving unit 111. The file list information 131 is, for example, information including file names and the like stored in the information storage area 130. The information adding unit 112 then adds information pertaining to the specific file (file that are not normally written over or erased by an application) to the file list information 131 obtained from the information storage area 130.

The information transmitting unit 113 transmits the file list information 131 to which the information pertaining to the specific file has been added by the information adding unit 112, to the application that transmitted the transmission command of the file list information 131 to the OS.

The application determining unit 114 determines whether the transmission source of the operating command transmitted to the OS is malware when the command receiving unit 111 hooks the operating command of the files transmitted from the application. Specifically, the application determining unit 114 determines that the transmission source of the operating command transmitted to the OS is malware when the operating command hooked by the command receiving unit 111 is a write command or an erase command with regard to the specific file.

(Outline of First Embodiment)

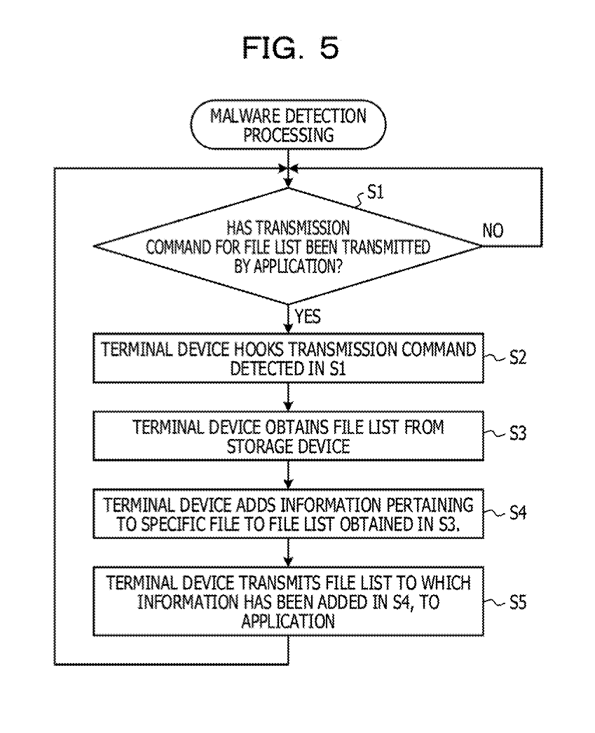

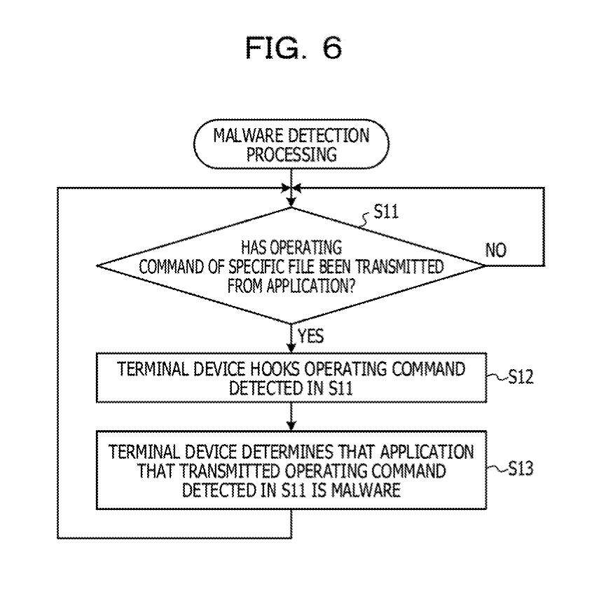

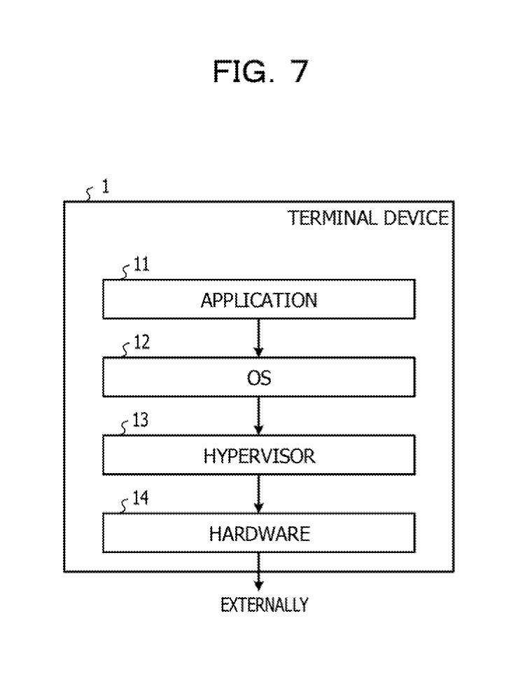

The following is an explanation of an outline of the first embodiment. FIGS. 5 and 6 is a flow chart for explaining an outline of malware detection processing according to a first embodiment. FIGS. 7 to 10 are views for explaining an outline of malware detection processing according to the first embodiment. The outline of the malware detection processing in FIGS. 5 and 6 will be explained while referring to FIGS. 7 to 10.

A configuration of the terminal device 1 will be discussed first. FIG. 7 is a view for explaining a configuration of the terminal device 1.

A hypervisor 13 in the terminal device 1 depicted in FIG. 7 operates on hardware 14 (physical resource) of the terminal device 1 and creates or erases a virtual machine. Specifically, the hypervisor 13 creates an OS 12 (referred to below as guest OS 12) in the hypervisor 13 and allocates a portion of the hardware 14 as virtual hardware of the virtual machine when a virtual machine is created in the terminal device 1. The hypervisor 13 erases the OS 12 created in the hypervisor 13 and releases the virtual hardware of the virtual machine when the virtual machine created in the terminal device 1 is erased.

While the hypervisor 13 depicted in FIG. 7 operates directly on the hardware 14, the hypervisor 13 may be one that operates on a host OS (not illustrated) run on the hardware 14. That is, the hypervisor 13 depicted in FIG. 7 is not a hypervisor that runs on a host OS but is a hypervisor (type-1 hypervisor) that runs directly on the hardware 14. Conversely, the hypervisor 13 may be a hypervisor (type-2 hypervisor) that runs on a host OS that runs directly on the hardware 14.

The flow chart depicted in FIGS. 5 and 6 will be discussed next. The hypervisor 13 of the terminal device 1 waits until a transmission command for the file list information 131 is transmitted by the application 11 as depicted in FIG. 5 (S1: No). Specifically, the hypervisor 13 waits until it is detected that a transmission command for the file list information 131 has been transmitted from the application 11 to the OS 12, or until it is detected that a transmission command for the file list information 131 transmitted by the application 11 has been received by the OS 12.

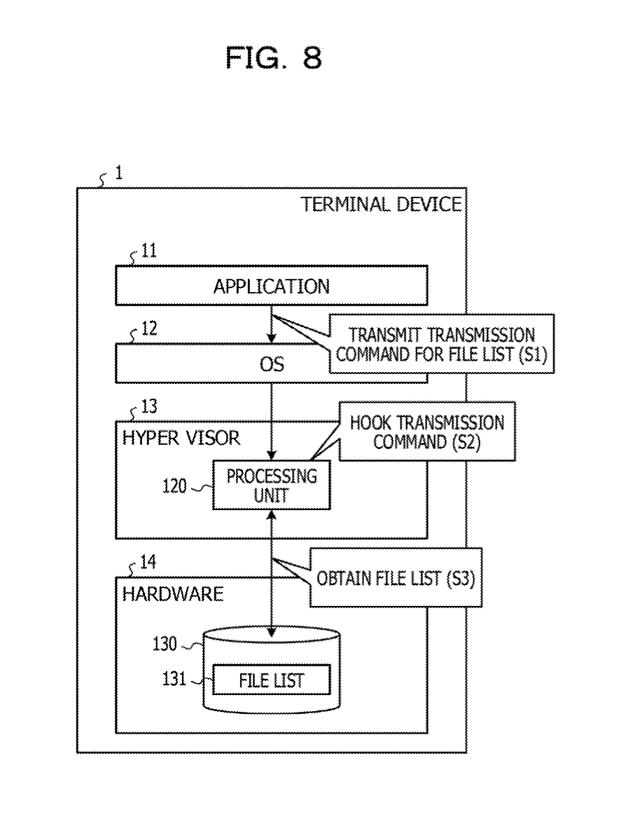

When the transmission command for the file list information 131 has been transmitted (S1: Yes), the hypervisor 13 hooks the detected transmission command transmitted by the application 11 in step S1 as depicted in FIG. 8 (S2). Next, the hypervisor 13 obtains the file list information 131 from the information storage area 130 (S3). That is, the hypervisor 13 in this case hooks the transmission command for the file list information 131 transmitted by the application 11 and carries out the processing corresponding to the transmission command.

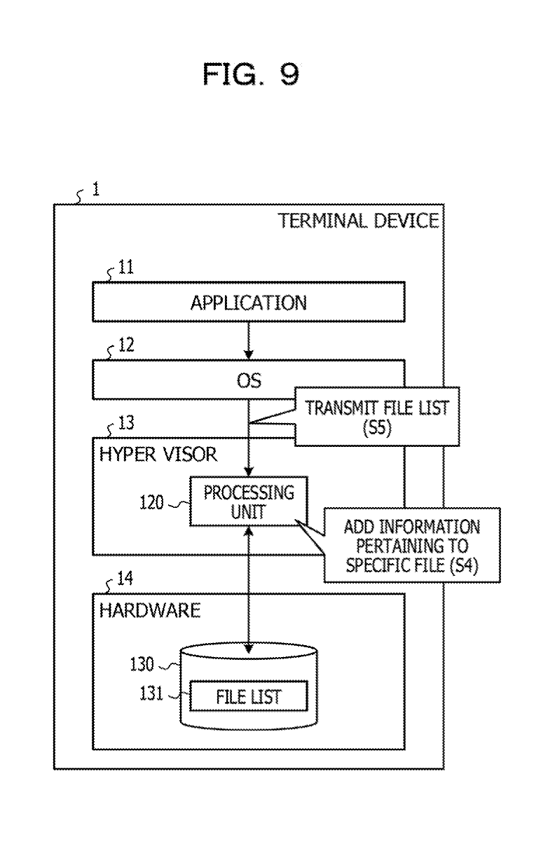

The hypervisor 13 then adds information pertaining to a specific file to the file list information 131 obtained in step S3 as depicted in FIG. 9 (S4). The hypervisor 13 transmits, to the application 11, the file list information 131 to which the information has been added in step S4 (S5).

That is, the hypervisor 13 adds the information pertaining to the specific file to the file list information 131 obtained due to the processing corresponding to the transmission command for the file list information 131, and transmits the file list information 131 to the application 11. As a result, the hypervisor 13 is able to determine whether the transmission source of the operating command is malware with respect to the specific file as explained below.

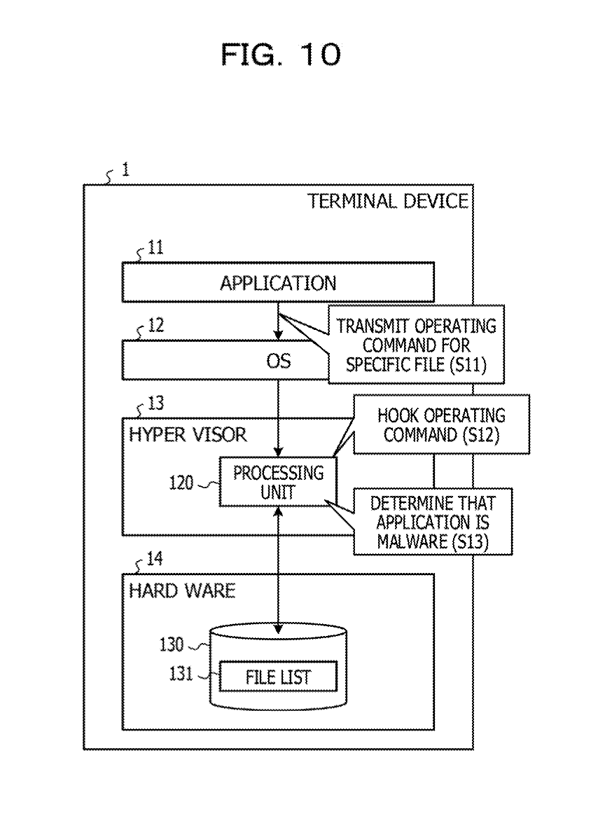

The hypervisor 13 waits until an operating command of the specific file is transmitted by the application 11 as depicted in FIG. 6 (S11: No). If an operating command of the specific file is transmitted by the application 11 (S11: Yes), the hypervisor 13 hooks the detected operating command transmitted in step S11 as depicted in FIG. 10 (S12). The hypervisor 13 then determines that the application 11 that transmitted the detected operating command transmitted in step S11 is malware (S13).

That is, a normal application 11 does not transmit an operating command with regard to the specific file which is a file created by the hypervisor 13. As a result, the hypervisor 13 is able to determine that when the operating command with regard to the specific file is transmitted, the transmission source is malware.

When the fact that the operating command of the specific file has been transmitted by the application 11 in step S11 is detected, the hypervisor 13 does not perform the processing corresponding to the operating command. As a result, the hypervisor 13 is able to avoid the expansion of damage due to the malicious action performed by the malware when the transmission source of the operating command is malware.

Moreover, the hypervisor 13 does not hook the operating command when it is detected that an operating command with regard to a file other than the specific file is transmitted by the application 11 in step S11. That is in this case, the hypervisor 13 allows the execution of the processing corresponding to operating commands performed by the OS 12. As a result, the hypervisor 13 is able to allow the execution of processing corresponding to operating commands that can be determined to have been performed by a normal application 11 (application 11 that is not malware).

In this way, the hypervisor 13 of the present embodiment receives (hooks) a transmission command for the file list information 131 from the application 11 and obtains the file list information 131 stored in the information storage area 130. Specifically, the hypervisor 13 obtains the file list information 131 when the transmission command for the file list information 131 transmitted by the application 11 is received by the OS 12.

The hypervisor 13 then adds information pertaining to the specific file created by the hypervisor 13 to the file list information 131 and transmits the file list information 131 to the application 11. Thereafter, the hypervisor 13 of the terminal device 1 determines that the application is a malware upon receiving an operating command with regard to the specific file from the application 11.

That is, when the specific file is a file created by the hypervisor 13, a normal application 11 does not have to carry out an operation such as writing over or erasing the specific file. As a result, the normal application 11 does not carry out an operation such as writing with regard to the specific file even if the information pertaining to the specific file is included in the obtained file list information 131.

Conversely, in the case in which the transmission source of the transmission command for the file list information 131 is malware (e.g., ransomware) that infects the terminal device 1, the malware, for example, attacks all of the files for which information is included in the obtained file list information 131. That is, when the transmission source of the transmission command for the file list information 131 is malware that infects the terminal device 1, the malware carries out an operation on the specific file created by the hypervisor 13.

The hypervisor 13 transmits the file list information 131 in which information pertaining to the specific file has been added, to the application 11 upon receiving the transmission command for the file list information 131 from the application 11. The hypervisor 13 then determines that the application 11 is malware upon receiving the operating command such as writing and the like with regard to the specific file from the application 11.

As a result, the hypervisor 13 is able to detect whether the transmission source of the transmission command for the file list information 131 is malware or not. Consequently, the hypervisor 13 is able to accurately detect the presence of the malware. Therefore, the hypervisor 13 is able to effectively avoid attacks on the files in the terminal device 1.

The hypervisor 13 of the present embodiment does not perform the malware detection processing in response to the transmission, from the application 11, of a command (referred to below as a VM detection command) for asking about whether the execution environment is a virtual machine. As a result, the hypervisor 13 is able to detect the malware even if the malware that has infected the terminal device 1 does not transmit a VM detection command.

(Details of First Embodiment)

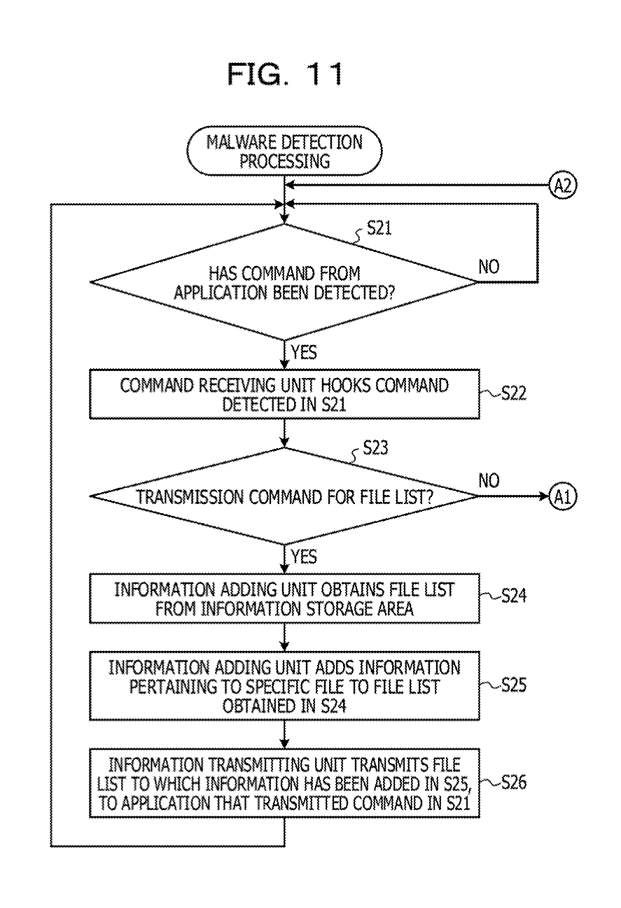

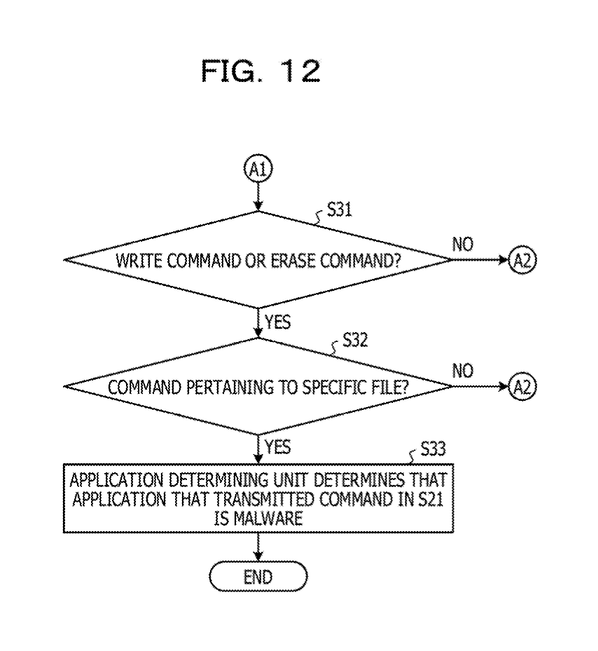

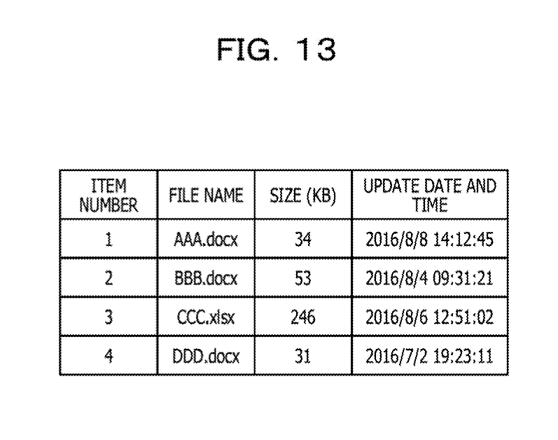

The following is an explanation of details of the first embodiment. FIGS. 11 and 12 is a flow chart for explaining details of malware detection processing according to the first embodiment. FIGS. 13 to 16 are views for explaining details of malware detection processing according to the first embodiment. The malware detection processing in FIGS. 11 and 12 will be explained while referring to FIGS. 13 to 16.

The command receiving unit 111 of the hypervisor 13 waits until the transmission of a command from the application 11 to the OS 12 is detected (S21: No). When the transmission of a command from the application 11 is detected (S21: Yes), the command receiving unit 111 hooks the command detected in the processing in step S21 (S22).

Next, the information adding unit 112 of the hypervisor 13 determines whether the command obtained in the processing of S21 is a transmission command for the file list information 131 (S23). Consequently, when the command obtained in the processing of S21 is a transmission command for the file list information 131 (S23: Yes), the information adding unit 112 obtains the file list information 131 from the information storage area 130 (S24). A detailed example of the file list information 131 stored in the information storage area 130 will be explained next.

(Detailed Example (1) of File List Information)

FIG. 13 is a diagram for explaining a detailed example of the file list information 131. The file list information 131 depicted in FIG. 13 includes fields such as an “Item Number” for identifying each piece if information included in the file list information 131, a “File Name” for identifying the file name of each file, and the “Size” for identifying the size of each file. The file list information 131 depicted in FIG. 13 also includes the field of “Update Date and Time” which indicates the latest update date and time for each file.

Specifically, “AAA.docx” is set as the “File Name”, “34 (KB)” is set as the “Size”, and “2016/8/8 14:12:45” is set as the “Update Date and Time” in the information under the item number “1” in the file list information 131 depicted in FIG. 13. “BBB.docx” is set as the “File Name”, “53 (KB)” is set as the “Size”, and “2016/8/8 09:31:21” is set as the “Update Date and Time” in the information under the item number “2”.

Moreover, “CCC.xlsx” is set as the “File Name”, “246 (KB)” is set as the “Size”, and “2016/8/6 12:51:02” is set as the “Update Date and Time” in the information under the item number “3” in the file list information 131 depicted in FIG. 13. “DDD.docx” is set as the “File Name”, “31 (KB)” is set as the “Size”, and “2016/7/2 19:23:11” is set as the “Update Date and Time” in the information under the item number “4”.

Returning to FIG. 11, the information adding unit 112 adds information pertaining to a specific file in the file list information 131 obtained in the processing in step S24 (S25). A detailed example of the file list information 131 after the information pertaining to a specific file has been added in the processing in step S25 will be explained next.

(Detailed Example (2) of File List Information)

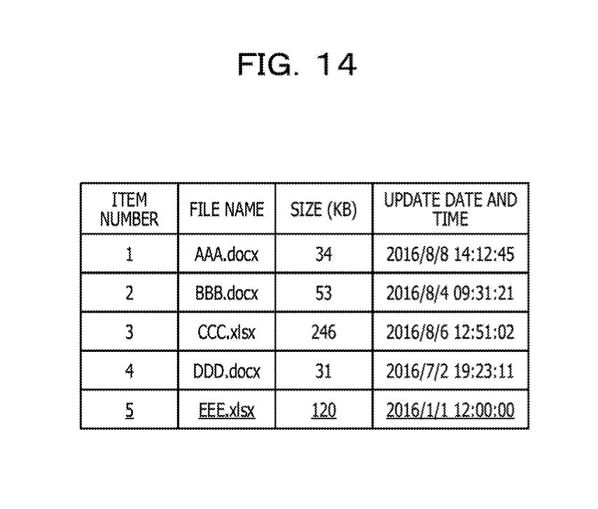

FIG. 14 is a diagram for explaining a detailed example of the file list information 131. The information adding unit 112 adds information pertaining to the specific file in the file list information 131 as explained in FIG. 13, for example, in the processing in step S25.

Specifically, the information adding unit 112 adds, to the file list information 131 explained in FIG. 13, information that includes the “File Name” of “EEE.xlsx”, the “Size” of “120 (KB)”, and the “Update Date and Time” of “2016/1/1 12:00:00” (information having the item number “5”) as depicted in the underlined portion in FIG. 14.

That is, the information adding unit 112 adds, to the file list information 131, information pertaining to a specific file that would not normally be written over or erased by the application 11. As a result, the application determining unit 114 of the hypervisor 13 is able to determine whether the application 11 is malware as explained below.

The information adding unit 112 may add information of a file that does not actually exist to the file list information 131 as the information pertaining to the specific file in the processing in S25. Furthermore, the information adding unit 112 may create the specific file by replicating a file that actually exists and adding information pertaining to the created specific file to the file list information 131.

The malware that has infected the terminal device 1 may perform the malicious action of encrypting or erasing files and the like in, for example, the order of the files included in the file names in the file list information 131. As a result, when the file name of the specific file is added to the file list information 131 in the middle of the list, for example, the hypervisor 13 is not able to determine that the transmission source of the transmission command for the file list information 131 is malware before the files in the terminal device 1 are subjected to the attack by the malware.

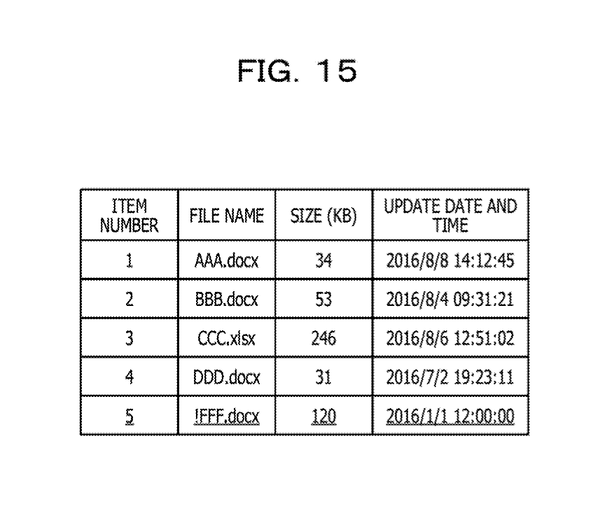

Accordingly, the information adding unit 112 decides the file name of the specific file so that the position of the file name of the specific file is as close as possible to the beginning of the file list information 131. Specifically, the information adding unit 112, for example, decides that the file name of the specific file is the file name of “!FFF.docx” in which “!” is added to the head of the file name. The information adding unit 112 then adds, to the file list information 131 explained in FIG. 13, information that includes the “File Name” of “!FFF.docx”, the “Size” of “120 (KB)”, and the “Update Date and Time” of “2016/1/1 12:00:00” (information having the item number “5”) as depicted in the underlined portion in FIG. 15.

As a result, the information adding unit 112 is able to determine that the application that transmitted the transmission command for the file list information 131 is malware before the files of the terminal device 1 are subjected to the attack by the malware.

Moreover, the information adding unit 112 desirably newly creates (decides) information (file name of specific file) pertaining to the specific file and adds the information to the file list information 131 each time a transmission command for the file list information 131 is transmitted from the application 11 in the processing in S25. The information adding unit 112 also preferably makes the extension of the file name of the specific file an extension (e.g., docx or xlsx) for a file that is very likely to be subjected to an attack by malware. The information adding unit 112 also preferably creates the specific file so as to be the same as an actual file such as a magic number and the like.

As a result of the above, the information adding unit 112 is able to conceal the fact that information pertaining to the specific file is included in the file list information 131 from a malicious person, for example, who transmits malware and the like.

Returning to FIG. 11, the information transmitting unit 113 of the hypervisor 13 transmits the file list information 131 to which the information has been added in the processing in S25, to the application 11 that transmitted the command in the processing in S21 (S26).

Moreover, if the command obtained in the processing in S21 is not a transmission command for the file list information 131 (S23: No), the application determining unit 114 determines whether the command obtained in the processing in S21 is a write command or an erase command pertaining to the files (S31). When it is determined that the command obtained in the processing in S21 is a write command or the like pertaining to the files (S31: Yes), the application determining unit 114 determines whether the command obtained in the processing in S21 is a command pertaining to the specific file.

As a result, if the command obtained in the processing in S21 is determined as a command pertaining to the specific file (S32: Yes), the application determining unit 114 determines that the application 11 that transmitted the command from the processing in S21 is malware (S33). The application determining unit 114 then finishes the malware detection processing after the processing in S33.

That is, when a write command or an erase command pertaining to the specific file is transmitted from the application 11, the application determining unit 114 determines that the write command or the erase command is a command transmitted for the purpose of attacking the files in the terminal device 1. As a result, the application determining unit 114 determines in this case that the application 11 that transmitted the write command or the erase command is malware.

However, when it is determined that the command obtained in the processing in S21 is a write command or the like pertaining to the files, or when it is determined that the command obtained in the processing in S21 is not a command pertaining to the specific file (S31: No, S32: No), the application determining unit 114 does not perform the processing in S33.

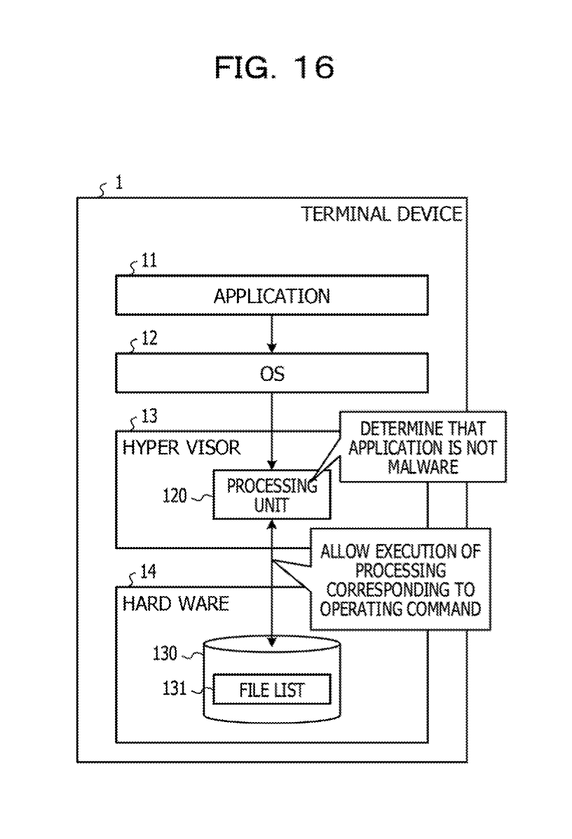

That is in this case, the application determining unit 114 determines that the application that transmitted the command obtained in the processing in S21 is not malware. As a result, the application determining unit 114 allows the execution of the processing (processing performed by the OS 12) corresponding to the operating command transmitted by the application 11 to the OS 12 as depicted in FIG. 16.

Even in the case of a normal application 11 (application 11 that is not malware), the reading of each file including the specific file may occur. As a result, the application determining unit 114 does not perform the processing from S32 onward when it is determined that the command transmitted from the application 11 is a read command.

In this way, the hypervisor 13 of the present embodiment receives the transmission command for the file list information 131 from the application 11 and obtains the file list information 131 stored in the information storage area 130. Specifically, the hypervisor 13 obtains the file list information 131 when the transmission command for the file list information 131 transmitted by the application 11 is received by the OS 12.

The hypervisor 13 then adds information pertaining to a specific file created by the hypervisor 13 to the file list information 131 and transmits the file list information 131 to the application 11. Thereafter, the hypervisor 13 of the terminal device 1 determines that the application is a malware upon receiving an operating command with regard to the specific file from the application 11.

That is, when the specific file is a file created by the hypervisor 13, a normal application 11 does not have to carry out an operation such as writing or erasing the specific file. As a result, the normal application 11 does not carry out an operation such as writing with regard to the specific file even when information pertaining to the specific file is included in the obtained file list information 131.

Conversely, if the transmission source of the transmission command for the file list information 131 is malware (e.g., ransomware) that has infected the terminal device 1, the malware, for example, attacks all of the files for which information is included in the obtained file list information 131. That is, if the transmission source of the transmission command for the file list information 131 is malware that has infected the terminal device 1, the malware carries out operations on the specific file created by the hypervisor 13.

The hypervisor 13 transmits the file list information 131 in which information pertaining to the specific file has been added, to the application 11 upon receiving the transmission command for the file list information 131 from the application 11. The hypervisor 13 then determines that the application 11 is malware upon receiving the operating command such as writing and the like with regard to the specific file from the application 11.

As a result, the hypervisor 13 is able to detect whether the transmission source of the transmission command for the file list information 131 is malware or not. Consequently, the hypervisor 13 is able to accurately detect the presence of the malware. Therefore, the hypervisor 13 is able to effectively avoid attacks on the files in the terminal device 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium for storing a program for malware detection, the program causing a computer to execute a process, the process comprising:
executing transmission processing that includes adding information pertaining to a specific file to a file list obtained from a storage device upon receiving a transmission command for the file list from an application, and transmitting, to the application, the file list to which the information pertaining to the specific file has been added; and
executing determination processing that includes determining that the application is malware upon receiving an operating command pertaining to the specific file from the application.

2. The non-transitory computer-readable medium according to claim 1, wherein the file list is information including file names of each file.

3. The non-transitory computer-readable medium according to claim 1, wherein the operating command is a write command or an erase command pertaining to the specific file.

4. The non-transitory computer-readable storage medium according to claim 1, wherein the write command is an encrypting command pertaining to the specific file.

5. The non-transitory computer-readable storage medium according to claim 1, wherein the transmission processing includes:
hooking the transmission command when the application transmits the transmission command to an operating system, and
adding the information pertaining to the specific file to the file list and transmitting the file list to the application; and
the determination processing includes:
hooking the transmission command when the application transmits the operating command to the operating system, and
performing a determination with regard to the application in response to the hooking of the operating command.

6. The non-transitory computer-readable medium according to claim 1, wherein the transmission processing includes:
adding information pertaining to the specific file before information pertaining to another file included in the file list.

7. The non-transitory computer-readable medium according to claim 1, wherein the transmission processing includes:
newly creating the information pertaining to the specific file, and
adding the newly created information pertaining to the specific file to the file list.

8. An apparatus for malware detection, the apparatus comprising:
a memory; and
a processor coupled to the memory and configured to:
execute command receiving processing that includes receiving a command from an application;
execute information adding processing that includes adding information pertaining to a specific file to a file list obtained from a storage device when the command from the application is a transmission command for requesting a transmission of a file list;
execute transmission processing that includes transmitting the file list to which the information pertaining to the specific file has been added, to the application that is the transmission source of the transmission command; and
execute determination processing that includes determining that the application is malware when the command from the application is an operating command for requesting an operation pertaining to the specific file.

9. A method for malware detection, the method comprising:
executing transmission processing that includes adding information pertaining to a specific file to a file list obtained from a storage device upon receiving a transmission command for the file list from an application, and transmitting, to the application, the file list to which the information pertaining to the specific file has been added; and
executing determination processing that includes determining that the application is malware upon receiving an operating command pertaining to the specific file from the application.
